(19) United States
(12) Patent Application Publication
(10) Pub. No.: US 2009/0183246 A1
(43) Pub. Date: Jul. 16, 2009

(54) Universal multi-factor authentication

(75) Inventor: Nick Kokologiannakis, San Jose, CA (US)

Correspondence Address: FSP LLC, P.O. BOX 890, VANCOUVER, WA, 98666, US

(73) Assignee: AuthLogic Inc., Santa Clara, CA (US)

(21) Appl. No.: 12/009,007

(22) Filed: Jan. 15, 2008

(51) Int. Cl. H04L 9/32; G06F 21/00

(52) U.S. Cl. 726/7

(57) ABSTRACT

An authentication system includes logic to receive and identify authentication requests from a plurality of service providers, each including a one time code. Unique ids are identified for users corresponding to each of the one time codes. The unique ids are applied to generate one time codes to compare with the one time codes received from the service providers. Authentication results are communicated to the service providers.

### TECHNICAL FIELD

The present disclosure relates to user authentication systems and techniques.

### BACKGROUND

User authentication is increasingly important in an era of electronic transactions and networked computing. A typical approach to user authentication involves collection of a user name and password (user primary credentials) before providing access to restricted information. This process is sometimes referred to as “basic authentication” of “primary authentication”.

A disadvantage of primary authentication is that as a user's name and password age, they are at greater risk of being exposed to third parties, either inadvertently or through affirmative measures of identity theft. A good example of how serious the problem can be is the theft of business laptop computers that store hundreds, thousands, or even millions of user primary credentials.

One manner of dealing with the dangers of compromised user primary credentials is secondary authentication. Secondary authentication may involve generation of a one-time code to supplement user primary credentials. Or the one time code along with the user name or other fixed credential may be used as primary authentication. The term “one time code” does not necessarily mean the code is only generated once. Rather, it refers to generating an authentication credential when the credential is needed, and typically using the credential once or only a few times before generating another, different authentication credential. This way, even if the code is compromised, it isn't valid for subsequent authentications of the user.

The one time code may be part of a sequence of codes each generated as needed, and then not used again (or used again only after a great many intervening codes are generated and potentially used). The codes may be independently generated by a user device and by a device of party that is authenticating the user. So long as the user device and the authenticating party are synchronized, the same one time code will be generated by both at the same point in the sequence, with a positive comparison and thus authentication of the user.

Prior approaches to generating one time codes involve the user applying a device provided by, and dedicated to, each authenticating party. This puts the user at the disadvantage of maintaining access to possible several code generating devices (e.g. one for online banking, one for online brokerage account, one for remote business access, and so on). It may create confusion as to which device is associated with which authenticating party. It increases the amount of information the user must assimilate in order to access various restricted accounts It also burdens each authenticating party with maintaining an installed base of code generating devices.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a block diagram of an embodiment of an authentication system.

FIG. 2 is a block diagram of an embodiment of a client device for generating one time authentication codes.

FIG. 3 is a flow chart of an embodiment of a centralized authentication process using one time codes.

FIG. 4 is a flow chart of an embodiment of a user authentication process by a central authentication authority.

FIG. 5 is a flow chart of an embodiment of a process of resyncing a one time code generator.

FIG. 6 is a flow chart of an embodiment of a secondary authentication process by a central authentication authority using one time codes.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

“Logic” refers to signals and/or information that may be applied to influence the operation of a device. Software, hardware, and firmware are examples of logic. Hardware logic may be embodied in circuits. In general, logic may comprise combinations of software, hardware, and/or firmware.

Those skilled in the art will appreciate that logic may be distributed throughout one or more devices, and/or may be comprised of combinations of instructions in memory, processing capability, circuits, and so on. Therefore, in the interest of clarity and correctness logic may not always be distinctly illustrated in drawings of devices and systems, although it is inherently present therein.

Techniques and systems are herein described which enable a single user device, such as a mobile phone, to generate one-time codes for all of the authenticating parties with which their user interacts. Consumers can subscribe to a single, simple service to provide the security of secondary authentication (or primary authentication with one-time codes) to all of their restricted accounts. Authenticating parties are freed from the burden of maintaining an installed base of code generating devices. Users and service providers have the peace of mind of knowing that even if primary credentials are compromised through inadvertence or deliberate theft, the security of the user's accounts will not be compromised.

As used herein, the term “service provider” refers to an entity providing access to information, services, or other resources via a computer data network (where ‘data’ refers to any type of computer encoded information). Examples of service providers are online brokers, online banking providers, portals (such as Yahoo™, MSN™, AOL™, etc.), social sites (FaceBook™, MySpace™, etc.), aggregators (Lexis-Nexis™, etc.) and generally any information, service, etc. that requires authentication of an accessing party. As used herein, when referring to multiple or a plurality (i.e. more than one) of service providers, the term shall mean multiple service providers who do not coordinate with one another for purposes of authenticating accessing parties.

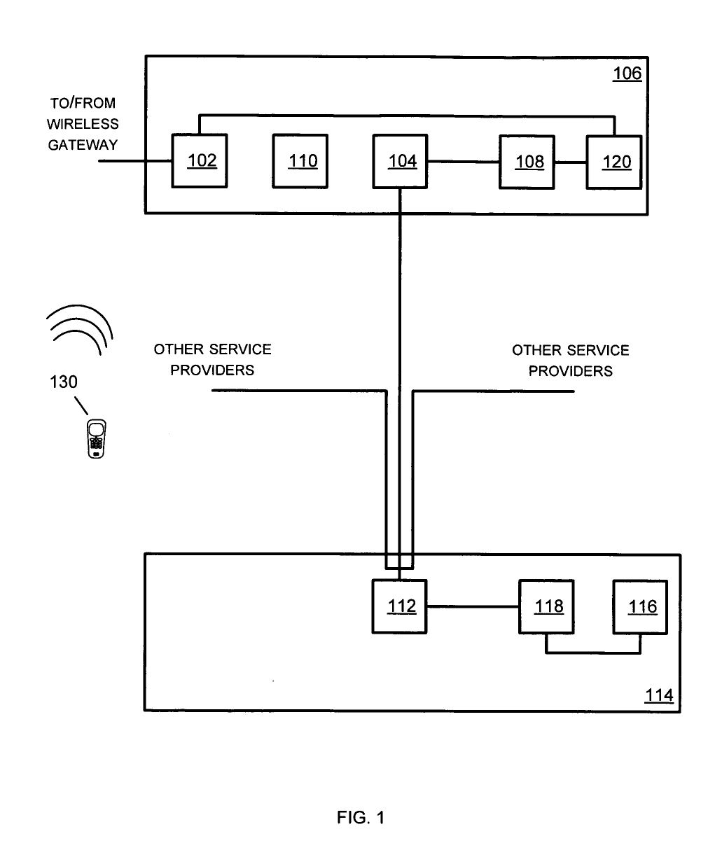

FIG. 1 is a block diagram of an embodiment of an authentication system. The system includes, but may not be limited to, a service provider data center 106 that includes: user account logic 102, authentication gateway logic 104, web server logic 108, administrative logic 110, and primary authentication logic 120.

The system further includes an authentication authority data center 114 comprising: user account logic 116, secondary authentication logic 118, and authentication gateway logic 112. Other elements and/or couplings among the elements have been omitted as they would be apparent to skilled practitioners in the relevant art(s).

The authentication authority is described as a centralized function. However, this need not be the case in every situation. A secondary authentication function may be provided in a more distributed fashion, for example using multiple authentication authorities, each associated with one or more service providers. In some situations, the authentication gateway logic 104 may be used to route authentication information to an appropriate authentication authority for the service provider.

Service Provider

The service provider data center 106 may comprise one or more computing devices hosting logic to implement the service provider user account database logic 102, the service provider authentication gateway logic 104, the web server logic 108, the administrative logic 110, and other operations not described so as not to obscure the present description unnecessarily. The data center may carry out the functions of the logic it comprises using, for example, one or more personal computers, laptops, routers, gateways, switches, and high-performance hardware and software platforms as provided, for example, by IBM™, Sun™, Hewlett Packard™, and other suppliers well known in the art.

The service provider user account logic 102 is a structured collection of information and associated management functions. The service provider user account 102 stores information about a user of the service provider, including for example static authentication credentials, billing information, preferences, and so on.

The service provider authentication gateway logic 104 is a logic component typically, although not necessarily, co-located with the service provider data center 106. The gateway 104 may provide secure communication of authentication credentials and verifications between the service provider data center 106 and the central authentication authority data center 114. The gateway 104 may be implemented as one or more software components operating in a secure environment capable of providing encrypted communication to and from an external network, such as the Internet. In some cases, communication may be further secured via a secure virtual network implemented within an open network architecture.

The web server logic 108 provides and manages interactions with users of the service provider. The web server 108 may communicate static and dynamic user interface data to user client devices, and may receive and process client interactions with the provided user interface data. For example the web server logic 108 may communicate Hypertext Markup Language(HTML), Extensible Markup Language(XML), JavaScript, VBScript, and other network user interface description and operation data formats via, for example, via Hypertext Transfer Protocol (HTTP) and secure variations thereof (e.g. HTTPS).

The administrative logic 110 provides administration and control of various functions of the data center 106, for example management and control of the user account 102, gateway logic 104, and web server 108.

The primary authentication logic 120 is a logic component typically, but not necessarily, co-located with service provider, providing primary authentication of user credentials. The primary authentication logic 120 may interact with service provider user account database logic 102 and compare provided primary credentials with securely stored credentials. In some implementations, primary authentication may be provided by the central authentication authority or some other third party.

Other examples and/or embodiments of the service provider user account 102, the service provider authentication gateway 104, the service provider data center 106, the web server 108, the administrative logic 110, and the primary authentication logic 120 may be apparent to skilled practitioners in the relevant art(s).

Central Authentication Authority

The authentication authority data center 114 may comprise one or more computing devices hosting logic to implement the authentication authority gateway 112, the authentication authority user account database 116, the secondary authentication 118, and other operations not described so as not to obscure the present description unnecessarily. See the description of the service provider data center 106 for examples of possible components of the authentication authority data center 114. The authentication authority data center 114 may be part of a telecommunication provider network, such as part of the back end of a wireless telecommunication provider network (Verizon™, Sprint™, AT&T™, etc.)

The gateway 112 is a logic component typically, though not necessarily, co-located with central authentication authority. The gateway 112 interacts with the service provider authentication gateway 104 to provide secure communication of authentication credentials and verifications between service provider and central authentication authority. The gateway 112 may be similar in many respects to the service provider authentication gateway 104, but may interact with many service provider gateways, for example one for each supported service provider.

The authentication authority user account database 116 is a structured collection of information and associated management. See the description of the service provider user account database logic 102 for examples of how the authentication authority user account database 116 may be implemented. Typically, the users represented in the authentication authority database 116 may be the users of the service providers that utilize the authentication authority.

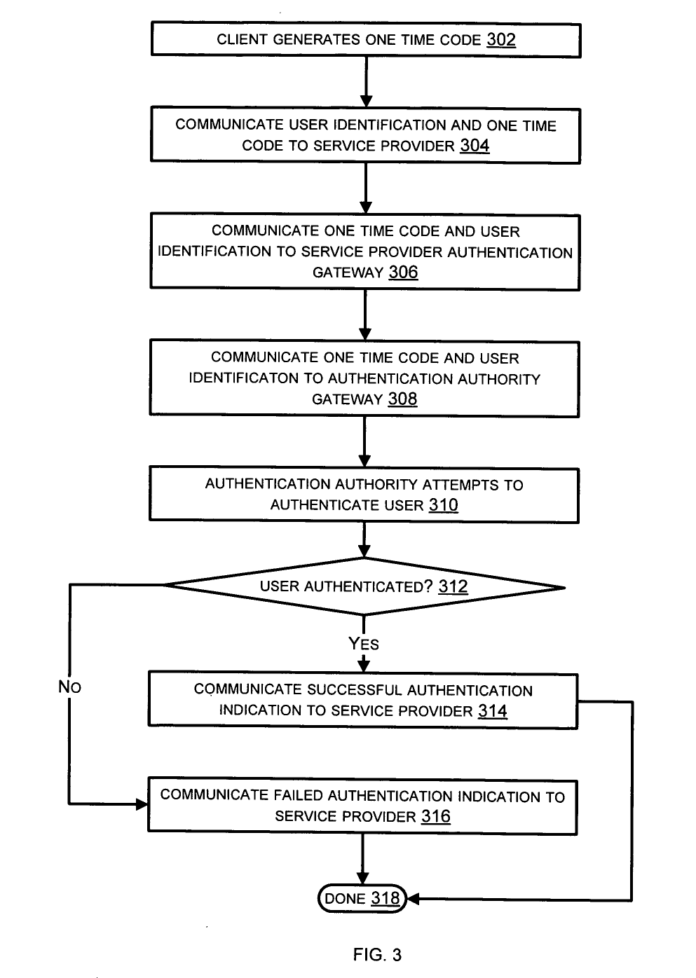

The secondary authentication logic 118 is a logic component typically, although not necessarily, co-located with the central authentication authority. The secondary authentication logic 118 may provide secondary authentication of user credentials, including one-time codes as described for example in conjunction with FIGS. 3-5. The secondary authentication logic 118 may interact with the account database 116 to compare user provided secondary credentials with locally generated one time codes.

Other examples and/or embodiments of the authentication authority gateway 112, authentication authority data center 114, authentication authority user account database 116, and the secondary authentication logic 118 may be apparent to skilled practitioners in the relevant art(s).

Primary and Secondary Authentication

Primary authentication may be provided in a number of ways, depending on the implementation. In one implementation, primary authentication is provided by performing basic authentication of the user's user name (or equivalent static identifier of the user) and a static password against information at least partially stored in the service provider user account database 102 (which may or may not actually be hosted by the service provider). In another implementation, primary authentication is provided by performing authentication of the user's user name (or equivalent static identifier of the user) and a dynamically generated one time code, against information at least partially stored in the authentication authority user account database 116.

In situations where secondary authentication is provided, primary (basic) authentication may first be provided as described above. A second authentication may also be provided, this time using at least in part the dynamically generated one-time code.

Authentication and communication of authentication information and verification between the authentication authority gateway 112 and the service provider authentication gateway 104 may take place in accordance with known procedures, for example Remote Authentication Dial In User Service (RADIUS) or DIAMETER protocols. RADIUS and DIAMETER (a successor technology to RADIUS) provide authentication, authorization, and accounting protocols in situations involving network access and IP (Internet Protocol) mobility.

A RADIUS solution may employ well-known authentication schemes like PAP, CHAP or EAP. A RADIUS solution may verify a user's credentials against a locally stored flat file database, or refer to external sources such as SQL, Kerberos, LDAP, or Active Directory servers.

A RADIUS solution will not transmit passwords or other user credentials in cleartext between the authentication authority gateway 112 and the service provider authentication gateway 104. Rather, a shared secret is used along with a hashing algorithm (such as MD5) to obfuscate confidential credentials. In more secure implementations, additional protection—such as IPSEC tunnels—may be used to further encrypt the RADIUS traffic.

Client Device

A user no longer is required to operate multiple code generation devices in order to gain the benefits of one-time code authentication with multiple service providers. Instead, the user can have a single device that generates one-time codes, and codes from this single device may be used with all service providers that are interactive with the central authentication authority. Each service provider is no longer burdened with maintaining an installed base of code generation devices.

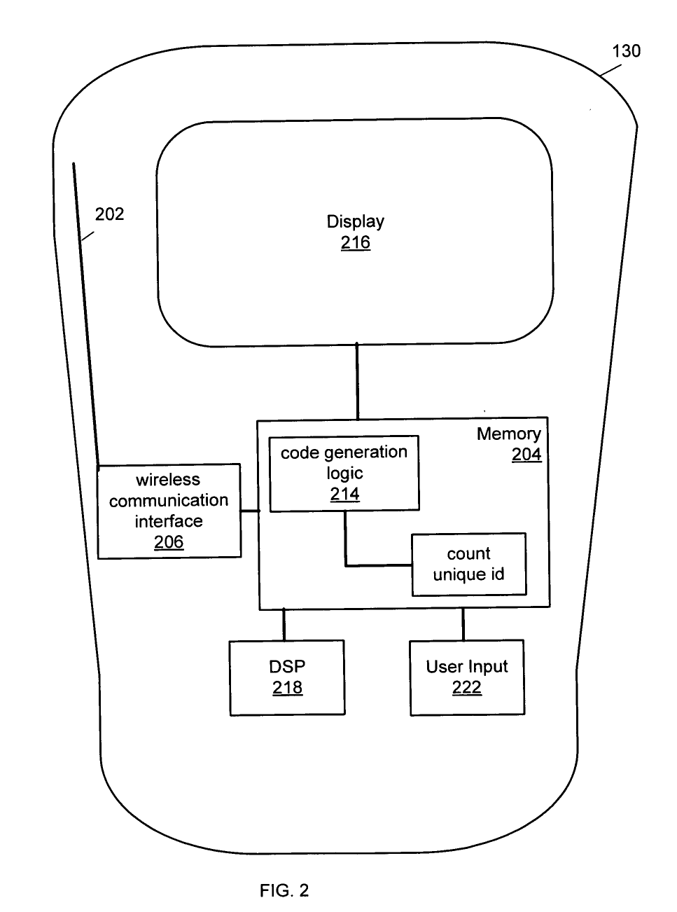

For example, as illustrated in FIG. 1, the client device may be a mobile phone 130. The phone 130 may comprise logic, as illustrated in FIG. 2, to generate one-time codes. The phone 130 may communicate with the service provider data center 106 via a wireless gateway, which is typically but not necessarily provided by the wireless service provider for the user of the phone.

Mobile phones are not the only type of client that may be employed. Other examples are handheld or laptop computers, personal computers, PDAs, portable music players, and any other client device with sufficient processing capability to generate and communicate one-time codes.

Note also that the user may not always use the same device to interacting with the service provider data center and to generate the one-time codes. For example, a user may use a mobile phone to generate the one-time code, and a laptop or personal computer to interact with web pages of the service provider. The user might cause the mobile phone to communicate the one-time code to the personal or laptop computer (or other device), from which it would be communicated to the service provider data center 106. Or the user might type the one-time code displayed on the display of the mobile phone into a browser or other communication logic of the laptop etc. from which it could be communicated to the data center 106.

FIG. 2 is a block diagram of an embodiment of a client device for generating one time authentication codes. The device 130 includes a display 216, a memory 204, a processor 218 (such as a digital signal processor, DSP), and a user input 222 (keyboard, roller, buttons, touch screen logic, voice input, etc.). The device 130 communicates wirelessly via a communication interface 206 and antenna 202. Technologies such as 2G and 3G for wireless phone communications are well known. The wireless interface 202 and 206 may also include mechanisms for short-range wireless communication, such as BlueTooth™ capability for communication with a personal or laptop computer, WiFi, and so on.

The memory 204 may include code generation logic 214 and at least two pieces of information in support thereof: a count, and a unique id. The unique id may be a device serial number, IMSI (International Mobile Subscriber Identifier), SIM ID (subscriber identity module ID), or other unique identifier of the device 130 and/or a user thereof.

One manner of generating a one-time code will be described; others will be apparent to those skilled in the art.

The code generation logic 214 may apply the unique id and count (i.e. sequence number) to generate a one-time code, for example using the SHA1 hash algorithm or some other technique.

Depending on the implementation, the generated id may be communicated by the device 130 to the service provider data center 106, or it may be displayed on the display 216 so that the user may enter it into another device that is in communication with the data center 106.

Primary and Secondary Authentication

FIG. 3 is a flow chart of an embodiment of a centralized authentication process using one time codes. At 302 a client device, such as a mobile phone, generates a one time code. In some implementations, this may be accomplished by applying a stored sequence value (e.g. count) as well as a “seed” value (a unique id) to a code generation process such as SHA1 hash algorithm. At 304 an identification of the user seeking to be authenticated and the one time code may be communicated to an on-line service provider, such as an online banking site, a web portal site, an online brokerage site, and so on. The user id may take many forms; it may be a “friendly” id the user has selected for the site, it may be the id of the user's account with a central authentication authority, it may be a unique id for the device that generated the one time code, and so on. In some situations, the service provider may locate the user id in a user account database, corresponding to a friendly id provided by the user for the service provider site.

The one time code and user id are communicated to the authentication authority, typically via a public network facility such as the Internet (308). The authentication authority attempts to authenticate the user (310), which, if successful (312-314), results in a communication of successful authentication back to the service provider. Otherwise, communication of an unsuccessful authentication is made to the service provider (316). At 318 the process concludes.

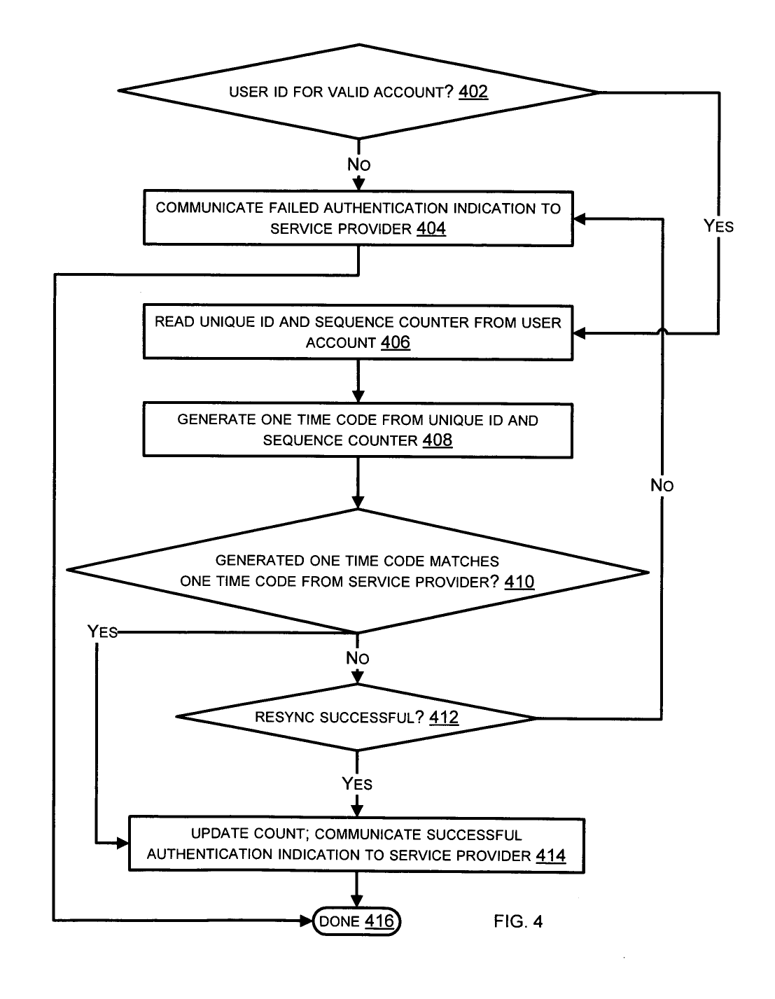

FIG. 4 is a flow chart of an embodiment of a user authentication process by a central authentication authority. If the received user id (which may be a friendly id, an account number, a device serial number or other device id, and so on) corresponds to a valid user account with the authentication authority (402-406), a unique id and count values for generating a one time code are read from the user's account. In some implementations, the received user id and the unique id are the same; in others, a lookup process to correspond the two takes place.

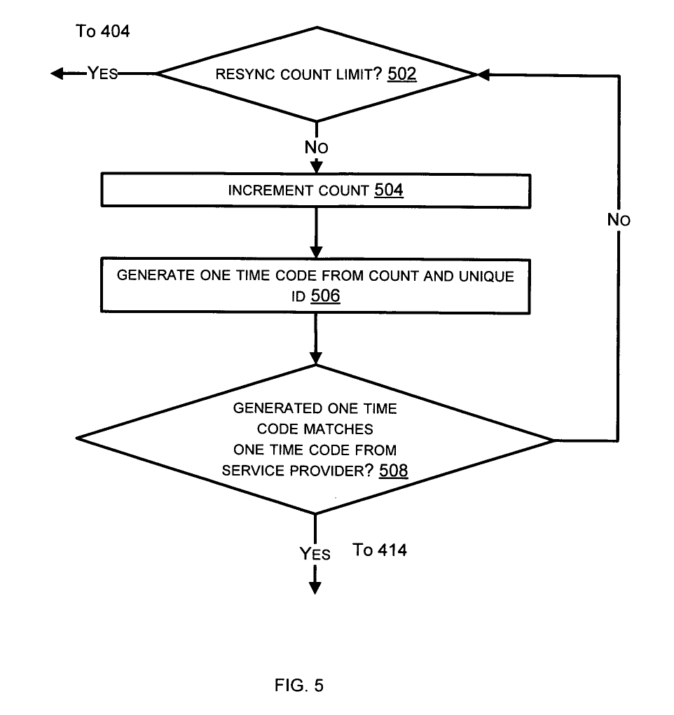

The one time code is generated (408). If the generated one time code matches the received one time code (410-414), the count value is updated in the user account, and an indication of successful authentication is communicated to the service provider. Otherwise, in some implementations a “resync” of the code generator with the one that produced the received one time code may be attempted (412). One embodiment of a resync process is described in conjunction with FIG. 5.

If the user id is not for a valid account (402-404), a failed authentication indication is communicated back to the service provider, and the process concludes (416).

FIG. 5 is a flow chart of an embodiment of a process of resyncing a one time code generator. Resyncing may be employed in situations where, for various reasons such as failed communication links or uncompleted transactions, the code generator of a client device “gets ahead” of the code generator of the authentication authority. In these situations the count applied by the code generator of the authentication authority must be brought into agreement with the count of the client device.

The system will check if a resync count limit has been reached (502); if so, it will not attempt to further adjust the count and will indicate that authentication failed. If the limit has not been reached, the count may be incremented (504), the one time code for this count generated (506), and a comparison made to see if the newly generated code matches the received code (508). A match indicates that the client and authority have been synchronized again.

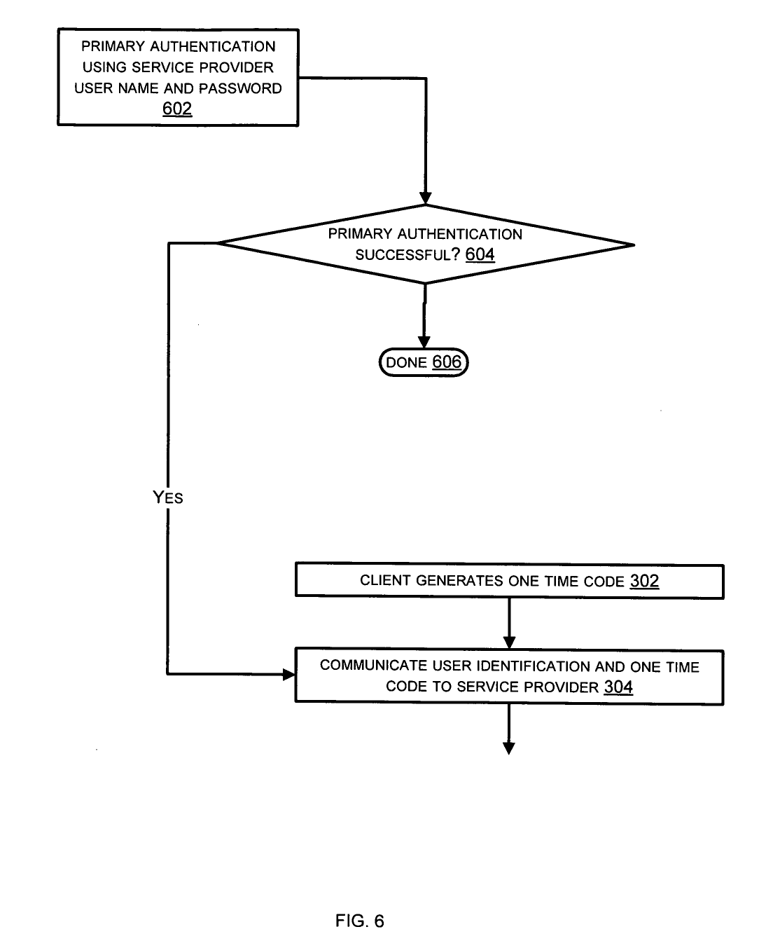

FIG. 6 is a flow chart of an embodiment of a secondary authentication process by a central authentication authority using one time codes. The service provider may perform a primary authentication of the user using primary credentials—user name and password, for example (602). If the primary authentication is successful (604-302), a secondary authentication may take place, for example as described in FIG. 3. Otherwise, the process concludes (606).

The secondary authentication may provide additional confidence in the identity of the user attempting to access restricted features of the service provider. Even if the user's primary credentials have been compromised, the secondary authentication will fail unless the person attempting access is in possession of the client device that generates one time codes for the user.

Those having skill in the art will appreciate that there are various vehicles by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations may involve optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

What is claimed is:

1. An authentication system comprising:
logic to receive a plurality of service provider authentication requests as a result of a user attempting to access each of the plurality of service providers;
logic to analyze each service provider authentication request at a central authentication authority, identify the user, and generate a one time code for each authentication request; and
logic to generate an authentication result for one or more of the service provider authentication requests based on comparing the one time code with the authentication request received from the service provider.

2. The authentication system of claim 1, wherein the logic to identify the users further comprises:
logic to identify unique ids in the authentication requests.

3. The authentication system of claim 2, wherein the logic to identify the user further comprises:
logic to identify in the authentication request one or more of a unique user identification or a unique client device identification.

4. The authentication system of claim 1, wherein the logic to generate a one time code further comprises:
logic to identify a stored count associated with each user and to apply the stored count to a sequence generator to generate a one time code corresponding to each user.

5. The authentication system of claim 4, wherein the logic to identify a stored count associated with each user and to apply the stored count to a sequence generator to generate a one time code further comprises:
logic to attempt to resync the sequence generator with a similar sequence generator that generated a one time code received with the authentication request.

6. An authentication system comprising:
logic to receive a user id and a one time code each corresponding to a user attempting to access a restricted service;
logic to identify the user id and to communicate the user and the one time code via a public network facility to an authentication authority; and
logic to receive and identify an authentication result for the user from the authentication authority.

7. The authentication system of claim 6, wherein the logic to identify a user id further comprises:
the user id is an account id for the user with the authentication authority.

8. The authentication system of claim 6, wherein the logic to identify a user id further comprises:
the user id received along with the one time code.

9. The authentication system of claim 6, wherein the logic to identify a user id further comprises:
the user id is an account id or device id associated with a user of a service provider.

10. The authentication system of claim 6, further comprising:
logic to perform a primary authentication of the user and if the primary authentication succeeds, to communicate the user id and one time code to the authentication authority for secondary authentication.

11. An authentication process comprising:
identifying authentication requests from a plurality of service providers, each including a one time code;
identifying users of the plurality of service providers, corresponding to the received one time codes;
generating user one time codes, corresponding to the identified users, to compare with the one time codes received from the service providers; and
communicating successful authentication results to the service providers for which there is a match of the received one time codes and the generated one time codes.

12. The authentication process of claim 11, wherein identifying users corresponding to each of the one time codes further comprises:
identifying unique ids in the authentication requests.

13. The authentication process of claim 12, wherein identifying unique ids in the authentication requests further comprises:
identifying in each authentication request one or more of a unique user identification or a unique client device identification.

14. The authentication process of claim 11, wherein applying the unique ids to generate one time codes to compare with the one time codes received from the service providers further comprises:
identifying a stored count associated with each unique id and applying the stored count to a sequence generator to generate a one time code corresponding to each unique id.

15. The authentication process of claim 14, wherein identifying a stored count associated with each unique id and applying the stored count to a sequence generator to generate a one time code corresponding to each unique id further comprises:
attempting to resync the sequence generator with a similar sequence generator that generated the one time code received with the authentication request.
